(19) United States
(12) Patent Application Publication
(10) Pub. No.: US 2022/0284177 A1
(43) Pub. Date: Sep. 8, 2022

(54) COMPUTER-READABLE RECORDING MEDIUM STORING RESPONSE SERVICE ASSISTANCE PROGRAM, RESPONSE SERVICE ASSISTANCE DEVICE, AND RESPONSE SERVICE ASSISTANCE METHOD

(71) Applicant: FUJITSU LIMITED, Kawasaki-shi (JP)

(72) Inventors: Kazuhiro Nakamura, Ota (JP); KAZUTO SHINOZAKI, Kawasaki (JP)

(73) Assignee: FUJITSU LIMITED, Kawasaki-shi (JP)

(21) Appl. No.: 17/826,238

(22) Filed: May 27, 2022

Related U.S. Application Data
(63) Continuation of application No. PCT/JP2019/048535, filed on Dec. 11, 2019.

(51) Int. Cl. G06F 40/166; G06F 40/242; G10L 15/26

(52) U.S. Cl. CPC G06F 40/166; G06F 40/242; G10L 15/26

(57) ABSTRACT

A non-transitory computer-readable recording medium stores a response service assistance program for causing a computer to execute a process including: acquiring voice data in a response service; converting the acquired voice data into text data; specifying search target data included in the converted text data; and designating which of a text search for the search target data or a transition process to dealing with the response service is to be executed, according to a ratio of the search target data to the text data.

### CROSS-REFERENCE TO RELATED APPLICATION

This application is a continuation application of International Application PCT/JP2019/048535 filed on Dec. 11, 2019 and designated the U.S., the entire contents of which are incorporated herein by reference.

### FIELD

The embodiments discussed herein are related to a response service assistance program, a response service assistance device, and a response service assistance method.

### BACKGROUND

In the past, the development of a response service assistance device that assists an operator by applying artificial intelligence to response services (for example, services for responding to product orders, inquiries relating to products, complaints, and the like from customers) in contact centers, call centers, and the like has been in progress.

Japanese Laid-open Patent Publication No. 07-36481, Japanese Laid-open Patent Publication No. 06-96129, Japanese Laid-open Patent Publication No. 07-78183, and Japanese Laid-open Patent Publication No. 2004-29138 are disclosed as related art.

### SUMMARY

According to an aspect of the embodiments, a non-transitory computer-readable recording medium stores a response service assistance program for causing a computer to execute a process including: acquiring voice data in a response service; converting the acquired voice data into text data; specifying search target data included in the converted text data; and designating which of a text search for the search target data or a transition process to dealing with the response service is to be executed, according to a ratio of the search target data to the text data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration of a response service assistance system;

FIG. 2 is a diagram illustrating an example of a hardware configuration of a response service assistance device;

FIG. 3 is a diagram illustrating an example of a functional configuration of a search unit;

FIG. 4 is a diagram illustrating details of a functional configuration and a specific example of processing of an erroneous conversion correction unit;

FIG. 5 is a diagram illustrating details of a functional configuration and a specific example of processing of a determination unit;

FIG. 6 is a diagram illustrating details of a functional configuration of a text search unit;

FIG. 7 is a diagram illustrating a specific example of product code data;

FIG. 8 is a diagram illustrating a specific example of processing of an exact match character calculation unit;

FIG. 9 is a diagram illustrating a specific example of similar pronunciation word dictionary data;

FIG. 10 is a diagram illustrating a specific example of processing of a half-match character calculation unit;

FIG. 11 is a diagram illustrating a specific example of processing of a similarity calculation unit;

FIG. 12 is a diagram illustrating a specific example of processing of a modification unit; and

FIG. 13 is an example of a flowchart illustrating a flow of a search process.

### DESCRIPTION OF EMBODIMENTS

In assisting the operator in such response services, it is expected to accurately perform voice recognition on the utterance content during a voice call.

However, when the operator is assisted in response services using a versatile voice recognition engine, merely, the voice data is converted into text data.

One aspect aims to provide appropriate operator support according to the acquired voice data in response services.

Hereinafter, each embodiment will be described with reference to the accompanying drawings. Note that, in this specification and the drawings, components having substantially the same functional configuration are denoted by the same reference signs, and redundant description will be omitted.

### First Embodiment

<System Configuration of Response Service Assistance System>

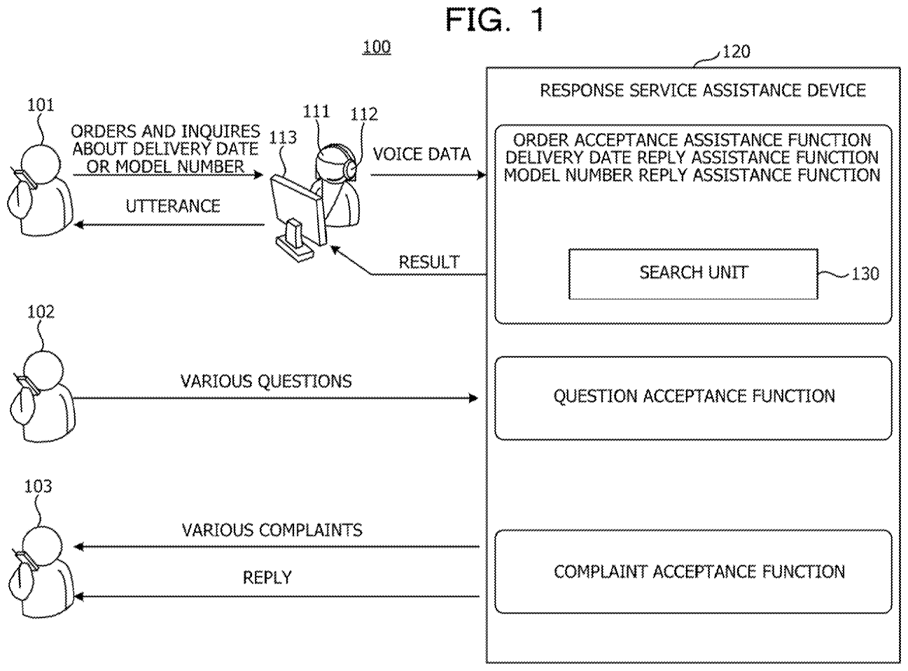

First, a system configuration of a response service assistance system will be described. FIG. 1 is a diagram illustrating an example of a system configuration of the response service assistance system. As illustrated in FIG. 1, a response service assistance system 100 is a system that assists an operator in response services for customers 101 to 103 and the like and includes:
a microphone 112 that detects the utterance of an operator 111 during a voice call with the customer 101 and generates voice data;
a response service assistance device 120 that performs processing for assisting the operator 111 based on the generated voice data or processing for responding various questions and various complaints from the customers 102 and 103; and
a terminal 113 that displays the result of the processing for assisting the operator 111 performed in the response service assistance device 120 to the operator 111.

In addition, as illustrated in FIG. 1,

the response service assistance device 120 has:
an order acceptance assistance function, a delivery date reply assistance function, and a model number reply assistance function;
a question acceptance function; and
a complaint acceptance function.

Among these functions, for example, when a product is ordered from the customer 101, the order acceptance assistance function performs voice recognition on the product code repeated by the operator 111 and displays the result of the voice recognition on the terminal 113. In addition, for example, when the customer 101 inquires about the delivery date of a product, the delivery date reply assistance function performs voice recognition on the product code repeated by the operator 111 and grasps the delivery date for the product according to the result of the recognition, by referring to a database (not illustrated). Furthermore, the delivery date reply assistance function displays the grasped delivery date on the terminal 113.

Moreover, for example, when the customer 101 inquires about the product code, the model number reply assistance function performs voice recognition on the product code repeated by the operator 111 and displays the result of the voice recognition on the terminal 113.

The order acceptance service, delivery date reply service, and model number reply service all include utterances specific to the services (utterances relating to the product code), and these response services may be deemed as “services involving performing voice recognition of the product code with high accuracy”. Therefore, the order acceptance assistance function, the delivery date reply assistance function, and the model number reply assistance function use a search unit 130 at the time of execution.

When the voice data is converted into text data by voice recognition, the search unit 130 performs a text search for the product code corresponding to the converted text data. This allows the search unit 130 to output the precise product code as a result of voice recognition even when the text data contains a character that has been erroneously recognized. For example, according to the search unit 130, high recognition accuracy may be implemented regarding utterances specific to the services (note that details of the search unit 130 will be described later).

Meanwhile, the question acceptance function accepts various questions and the like of the customer 102, for example, at night or on holidays when the operator 111 is absent. The question acceptance function accepts free utterances by the customer 102.

In addition, the complaint acceptance function accepts, for example, various complaints from the customer 103 and makes a reply (apology or the like) according to the accepted complaint. Like the question acceptance function, the complaint acceptance function also accepts free utterances by the customer 103.

For example, in the case of the question acceptance service and the complaint acceptance service, both include free utterances, and these response services may be deemed as “services other than the service involving performing voice recognition of the product code with high accuracy”. Therefore, the question acceptance function and the complaint acceptance function do not use the search unit 130 at the time of execution.

In this manner, the response service assistance device 120 performs a text search by the search unit 130 when the current response service is a “service involving performing voice recognition of the product code with high accuracy”. This allows the response service assistance device 120 to perform voice recognition of the product code with high accuracy in the “service involving performing voice recognition of the product code with high accuracy”.

<Hardware Configuration of Response Service Assistance Device>

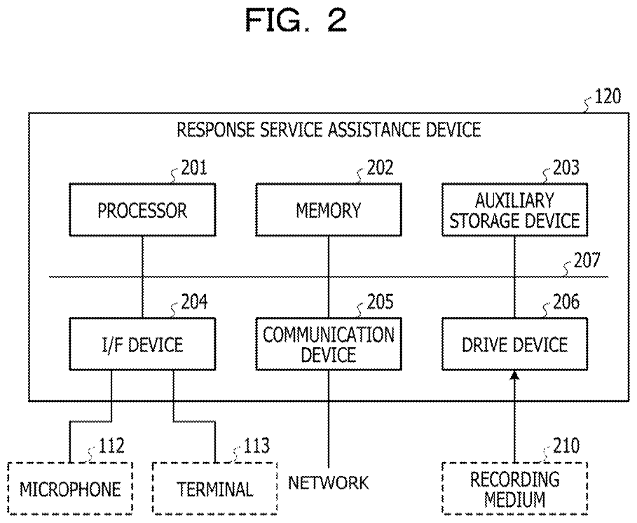

Next, a hardware configuration of the response service assistance device will be described. FIG. 2 is a diagram illustrating an example of a hardware configuration of the response service assistance device. As illustrated in FIG. 2, the response service assistance device 120 includes a processor 201, a memory 202, an auxiliary storage device 203, an interface (I/F) device 204, a communication device 205, and a drive device 206. Note that the respective pieces of hardware of the response service assistance device 120 are interconnected via a bus 207.

The processor 201 includes various arithmetic devices such as a central processing unit (CPU) and a graphics processing unit (GPU). The processor 201 reads various programs (for example, a response service assistance program described later, and the like) into the memory 202 and executes the read programs.

The memory 202 includes a main storage device such as a read only memory (ROM) and a random access memory (RAM). The processor 201 and the memory 202 form a so-called computer. The processor 201 executes various programs read into the memory 202 to cause the computer to implement various functions.

The auxiliary storage device 203 stores various programs and various pieces of data used when the various programs are executed by the processor 201. Note that an erroneous conversion dictionary storage unit, a product code data storage unit, and a similar pronunciation word dictionary storage unit, which will be described later, are implemented in the auxiliary storage device 203.

The I/F device 204 is a connection device that connects the microphone 112 and the terminal 113, which are examples of external devices, and the response service assistance device 120. The I/F device 204 receives the voice data transmitted from the microphone 112. In addition, the I/F device 204 transmits the result of processing in the response service assistance device 120 to the terminal 113.

The communication device 205 is a communication device for communicating with another device via a network (not illustrated).

The drive device 206 is a device in which a recording medium 210 is set. The recording medium 210 mentioned here includes a medium that optically, electrically, or magnetically records information, such as a compact disc read only memory (CD-ROM), a flexible disk, or a magneto-optical disk. Alternatively, the recording medium 210 may include a semiconductor memory or the like that electrically records information, such as a ROM or a flash memory.

Note that the various programs to be installed in the auxiliary storage device 203 are installed, for example, when the distributed recording medium 210 is set in the drive device 206, and the various programs recorded on the recording medium 210 are read by the drive device 206. Alternatively, the various programs to be installed on the auxiliary storage device 203 may be installed by being downloaded from a network via the communication device 205.

<Details of Functional Configuration of Response Service Assistance Device>

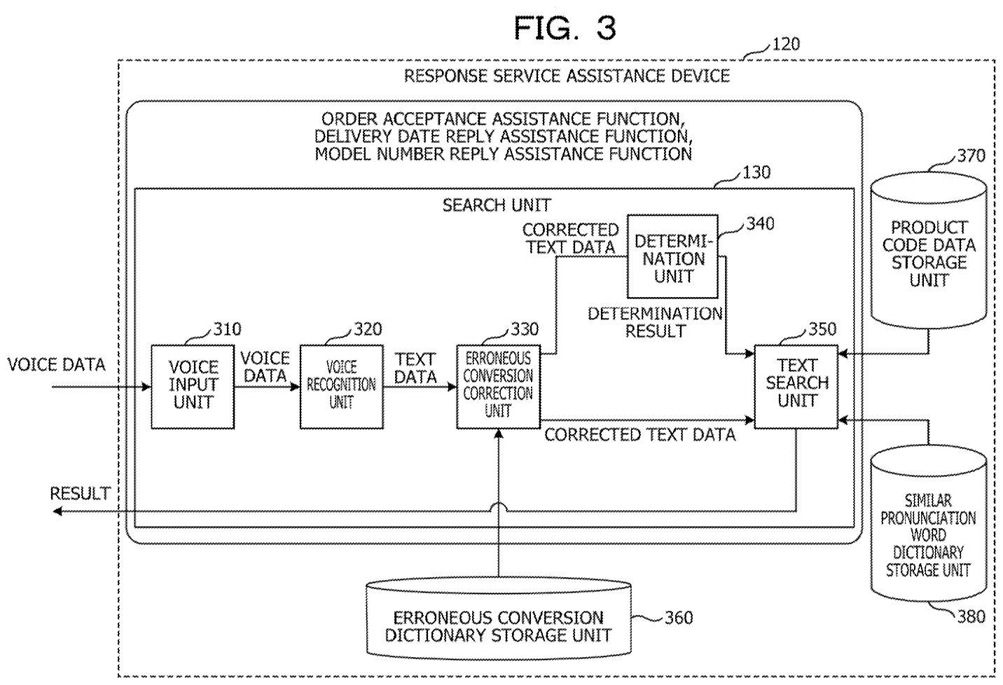

Next, a functional configuration of the search unit 130 used by the order acceptance assistance function, the delivery date reply assistance function, and the model number reply assistance function, among functions each implemented in the response service assistance device 120, at the time of execution will be described. FIG. 3 is a diagram illustrating an example of a functional configuration of the search unit.

As illustrated in FIG. 3, the search unit 130 includes a voice input unit 310, a voice recognition unit 320, an erroneous conversion correction unit 330, a determination unit 340, and a text search unit 350.

The voice input unit 310, which is an example of an acquisition unit, acquires the voice data transmitted from the microphone 112 and notifies the voice recognition unit 320 of the acquired voice data.

The voice recognition unit 320 is an example of a conversion unit. The voice recognition unit 320 includes a versatile voice recognition engine and converts the voice data into text data by performing voice recognition processing on the voice data notified by the voice input unit 310 to notify the erroneous conversion correction unit 330 of the converted text data.

The erroneous conversion correction unit 330 corrects a character erroneously recognized by the voice recognition unit 320, among the characters included in the text data notified by the voice recognition unit 320, by referring to an erroneous conversion dictionary. In addition, the erroneous conversion correction unit 330 notifies the determination unit 340 and the text search unit 350 of the corrected text data in which the erroneously recognized character has been corrected.

Based on the corrected text data notified by the erroneous conversion correction unit 330, the determination unit 340 determines whether or not the current response service is a “service involving performing voice recognition of the product code with high accuracy”.

When it is determined that the current response service is a “service other than the service involving performing voice recognition of the product code with high accuracy”, the search unit 130 ends the processing and executes a transition process to transition to a function for assisting another service. Note that the function for assisting another service mentioned here is assumed to refer to the question acceptance function, the complaint acceptance function, and the like.

On the other hand, when it is determined that the current response service is the “service involving performing voice recognition of the product code with high accuracy”, the search unit 130 notifies the text search unit 350 of the determination result.

When notified of the determination result by the determination unit 340, the text search unit 350 reads product code data from a product code data storage unit 370. In addition, the text search unit 350 performs a text search by comparing the product code data read from the product code data storage unit 370 and the corrected text data and calculating the similarity between the product code data and the corrected text data. Note that the text search unit 350 refers to a similar pronunciation word dictionary storage unit 380 when calculating the similarity.

Furthermore, the text search unit 350 sorts the product code data based on the calculated similarity and transmits product code data with the highest similarity (or product code data having a similarity equal to or higher than a predetermined threshold value) to the terminal 113 as a result of the voice recognition.

<Detailed Configuration of Each Unit Included in Search Unit>

Next, the details of a functional configuration and a specific example of processing of each unit (here, the erroneous conversion correction unit 330, the determination unit 340, and the text search unit 350) included in the search unit 130 will be described.

(1) Details of Functional Configuration and Specific Example of Processing of Erroneous Conversion Correction Unit

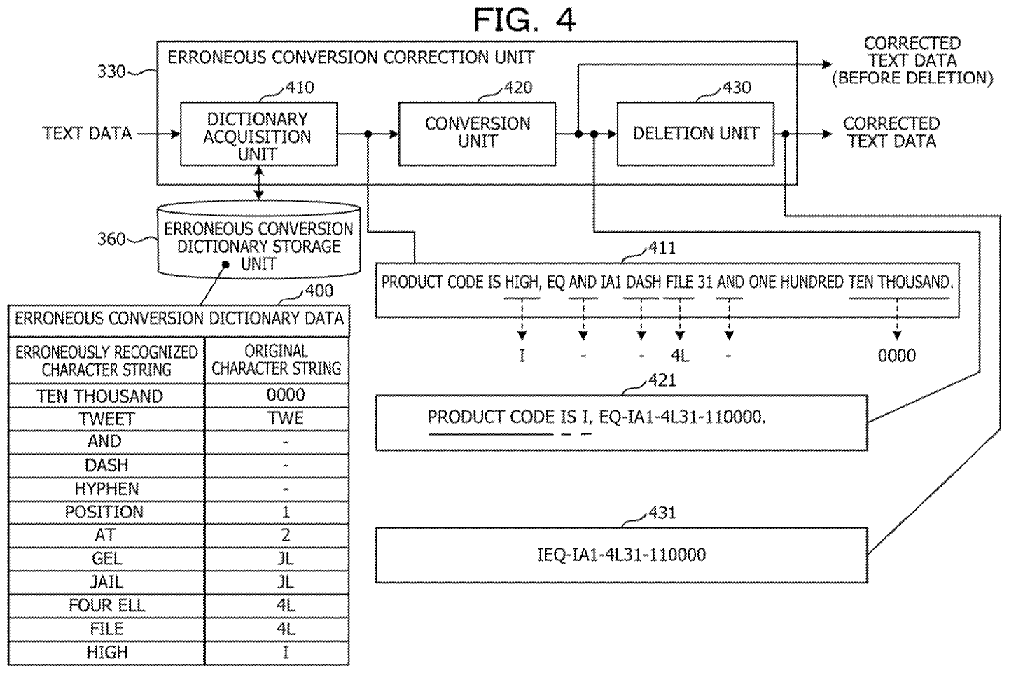

First, details of a functional configuration and a specific example of processing of the erroneous conversion correction unit 330 will be described. FIG. 4 is a diagram illustrating details of a functional configuration and a specific example of processing of the erroneous conversion correction unit. As illustrated in FIG. 4, the erroneous conversion correction unit 330 includes a dictionary acquisition unit 410, a conversion unit 420, and a deletion unit 430.

When notified of the text data by the voice recognition unit 320, the dictionary acquisition unit 410 acquires erroneous conversion dictionary data 400 from an erroneous conversion dictionary storage unit 360 and notifies the conversion unit 420 of the acquired erroneous conversion dictionary data 400. As illustrated in FIG. 4, the erroneous conversion dictionary data 400 includes an “erroneously recognized character string” and an “original character string” as information items.

The “erroneously recognized character string” stores a character string erroneously recognized when the versatile voice recognition engine included in the voice recognition unit 320 performed voice recognition on the voice data when the operator 111 read out the product code. In addition, the “original character string” stores a character string when precisely recognized. The erroneous conversion dictionary data 400 is generated by the operator 111 reading out all the product codes in advance.

Therefore, when there is a plurality of operators, the erroneous conversion dictionary data 400 is generated separately for each operator. This is because each operator has different habits and the like when reading out the product codes. In addition, when there is a plurality of services, the erroneous conversion dictionary data 400 is generated separately for each service. This is because there is a case where the product codes are named or called in different ways for each service. Note that the erroneous conversion dictionary data 400 merely indicates an example of erroneous conversion by the versatile voice recognition engine and may include erroneous conversions not described in the erroneous conversion dictionary data 400.

The conversion unit 420 corrects an erroneously recognized character included in the text data notified by the dictionary acquisition unit 410, based on the erroneous conversion dictionary data 400. In addition, the conversion unit 420 notifies the text search unit 350 of text data that has been corrected based on the erroneous conversion dictionary data 400 as the corrected text data (before deletion). Furthermore, the conversion unit 420 notifies the deletion unit 430 of the text data that has been corrected based on the erroneous conversion dictionary data 400 as the corrected text data (before deletion).

In FIG. 4, the reference sign 411 indicates a state in which the dictionary acquisition unit 410 has notified that “The product code is high, EQ and IA1 dash file 31 and one hundred ten thousand.”, as text data.

In addition, in FIG. 4, the reference sign 411 indicates a state in which, in the text data notified by the dictionary acquisition unit 410, the conversion unit 420 corrects
“high” to “I”,
“and” to “-”,
“dash” to “-”,
“file” to “4L”,
“and” to “-”, and
“ten thousand” to “0000”

individually based on the erroneous conversion dictionary data 400.

Furthermore, in FIG. 4, the reference sign 421 indicates the text data that has been corrected by the conversion unit 420 correcting the text data (reference sign 411) including the erroneously recognized characters.

Note that the example in FIG. 4 indicates a case where the operator 111 utters Japanese. However, for example, in a case where the operator 111 utters English and the voice recognition processing is performed by a versatile voice recognition engine for English, for example,

“The product code is IEQ dash IA One dash 31 dash 110000.”

or the like is notified as text data, and the conversion unit 420 corrects
“dash” to “-”
“One” to “1”, and
“dash” to “-”

individually. Alternatively, when

“The product code is PW eq900 1tb.”

or the like is notified as text data,

the conversion unit 420 makes corrections such as
deletion of spaces, and
conversion from lowercase to uppercase.

The deletion unit 430 deletes characters other than the product code from the corrected text data (before deletion) notified by the conversion unit 420. In addition, the deletion unit 430 outputs the corrected text data in which characters other than the product code have been deleted from the corrected text data (before deletion), to the text search unit 350.

In FIG. 4, the reference sign 431 indicates the corrected text data in which characters other than the product code (in the example in FIG. 4, “The product code is”, “,”, and “.”) have been deleted from the corrected text data (before deletion) (reference sign 421).

In this manner, the erroneous conversion correction unit 330 corrects or deletes characters that are not conceivable as a product code, from the characters each included in the text data.

(2) Details of Functional Configuration and Specific Example of Processing of Determination Unit

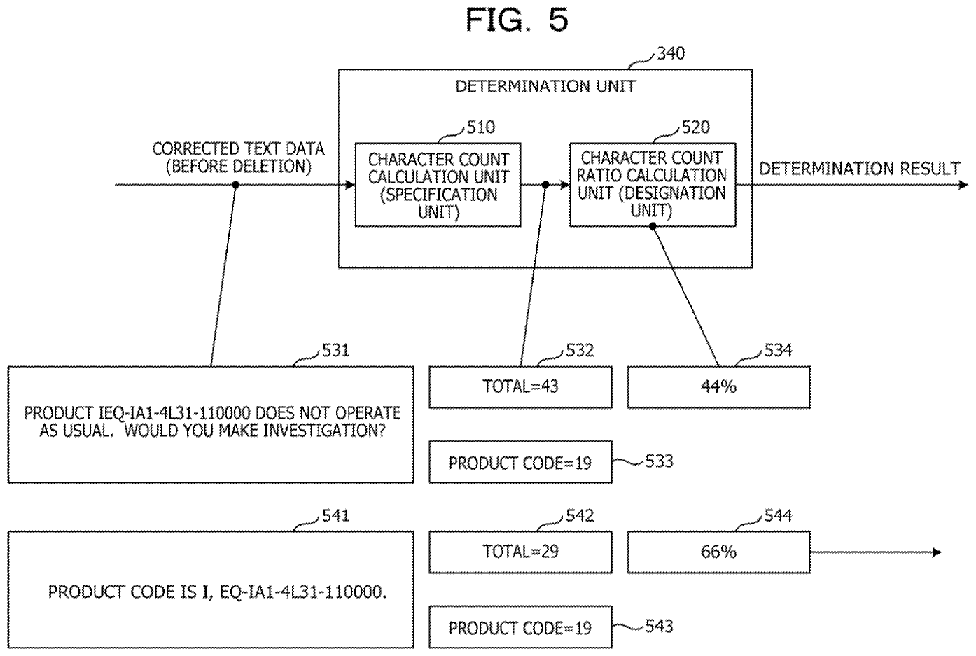

Next, details of a functional configuration and a specific example of processing of the determination unit 340 will be described. FIG. 5 is a diagram illustrating details of a functional configuration and a specific example of processing of the determination unit. As illustrated in FIG. 5, the determination unit 340 includes a character count calculation unit 510 and a character count ratio calculation unit 520.

The character count calculation unit 510 is an example of a specification unit. The character count calculation unit 510 calculates the total character count of the corrected text data (before deletion) notified by the erroneous conversion correction unit 330. In addition, the character count calculation unit 510 calculates the character count of characters (search target data) that relate to the product code and are included in the corrected text data (before deletion) notified by the erroneous conversion correction unit 330. Furthermore, the character count calculation unit 510 notifies the character count ratio calculation unit 520 of the calculated total character count and the character count of the characters (search target data) relating to the product code.

The character count ratio calculation unit 520 is an example of a designation unit. The character count ratio calculation unit 520 calculates the ratio of the character count of the characters (search target data) relating to the product code to the total character count. In addition, the character count ratio calculation unit 520 determines whether or not the calculated ratio is equal to or higher than a predetermined threshold value (equal to or higher than a predetermined value).

Here, when the ratio of the character count of the characters relating to the product code to the total character count is equal to or higher than the predetermined threshold value, the character count ratio calculation unit 520 determines that the current response service is the “service involving performing voice recognition of the product code with high accuracy”.

On the other hand, when the ratio of the character count of the characters relating to the product code to the total character count is lower than the predetermined threshold value (lower than the predetermined value), the character count ratio calculation unit 520 determines that the current response service is a “service other than the service involving performing voice recognition of the product code with high accuracy”.

Then, in the case of being equal to or higher than the predetermined threshold value, the character count ratio calculation unit 520 notifies the text search unit 350 of the determination result.

In this manner, the character count ratio calculation unit 520 determines whether or not the current response service is the “service involving performing voice recognition of the product code with high accuracy”, based on the ratio of the characters (search target data) relating to the product code to the corrected text data (before deletion).

The example in FIG. 5 indicates a state in which the corrected text data (before deletion) indicated by the reference sign 531 and the corrected text data (before deletion) indicated by the reference sign 541 are notified as the corrected text data (before deletion).

Among these pieces of the corrected text data, when the corrected text data (before deletion) indicated by the reference sign 531 is notified,

the character count calculation unit 510 calculates
the total character count=43 characters (refer to the reference sign 532), and
the character count of the characters relating to the product code (search target data)=19 characters (refer to the reference sign 533), and

the character count ratio calculation unit 520 calculates
the ratio of the character count of the characters relating to the product code (search target data) to the total character count=44% (refer to the reference sign 534). In this case, the character count ratio calculation unit 520 determines that the calculated ratio is lower than the predetermined threshold value and does not output the determination result to the text search unit 350.

Meanwhile, when the corrected text data (before deletion) indicated by the reference sign 541 is notified,

the character count calculation unit 510 calculates

the total character count=29 characters (refer to the reference sign 542), and
the character count of the characters relating to the product code (search target data)=19 characters (refer to the reference sign 543), and

the character count ratio calculation unit 520 calculates
the ratio of the character count of the characters relating to the product code (search target data) to the total character count=66% (refer to the reference sign 544). In this case, the character count ratio calculation unit 520 determines that the calculated ratio is equal to or higher than the predetermined threshold value and outputs the determination result to the text search unit 350.

(3) Details of Functional Configuration of Text Search Unit

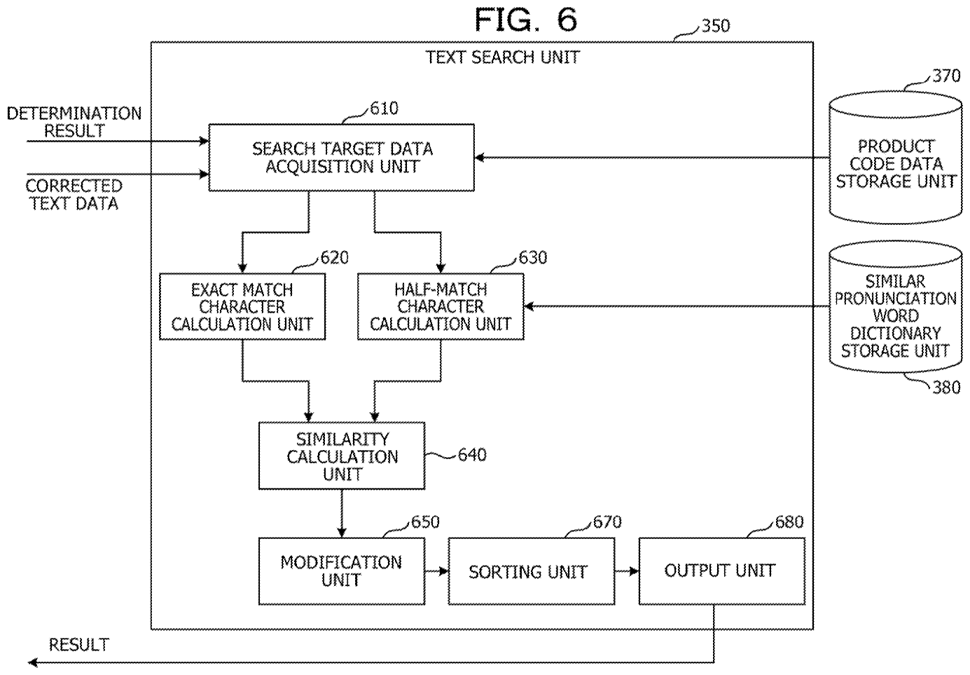

Next, details of a functional configuration of the text search unit 350 will be described. FIG. 6 is a diagram illustrating details of a functional configuration of the text search unit. As illustrated in FIG. 6, the text search unit 350 includes a search target data acquisition unit 610, an exact match character calculation unit 620, a half-match character calculation unit 630, a similarity calculation unit 640, a modification unit 650, a sorting unit 670, and an output unit 680.

When notified of the determination result by the determination unit 340, the search target data acquisition unit 610 acquires the corrected text data from the erroneous conversion correction unit 330. Note that, since characters other than the product code have been deleted from the corrected text data acquired from the erroneous conversion correction unit 330, the corrected text data acquired by the search target data acquisition unit 610 will be treated as the search target data thereafter.

When the corrected text data (search target data) is acquired, the search target data acquisition unit 610 reads the product code data from the product code data storage unit 370.

In addition, the search target data acquisition unit 610 notifies the exact match character calculation unit 620 and the half-match character calculation unit 630 of the acquired corrected text data (search target data) and the read product code data.

The exact match character calculation unit 620 compares the corrected text data (search target data) notified by the search target data acquisition unit 610 and the product code data and counts the character count of exact match characters. In addition, the exact match character calculation unit 620 notifies the similarity calculation unit 640 of the character count of exact match characters.

When notified of the corrected text data (search target data) and the product code data by the search target data acquisition unit 610, the half-match character calculation unit 630 reads similar pronunciation word dictionary data from the similar pronunciation word dictionary storage unit 380.

In addition, the half-match character calculation unit 630 makes a determination regarding characters other than the characters that exactly match the product code data in the corrected text data (search target data). For example, the half-match character calculation unit 630 determines whether or not the characters of the corrected text data (search target data) at each position and the characters of the product code data at each corresponding position have a relationship indicated by the similar pronunciation word dictionary data.

Furthermore, the half-match character calculation unit 630 notifies the similarity calculation unit 640 of the character count of characters (referred to as half-match characters) having the relationship indicated by the similar pronunciation word dictionary data between the characters of the corrected text data (search target data) at each position and the characters of the product code data at each corresponding position.

The similarity calculation unit 640 calculates the similarity based on the character count of the exact match characters notified by the exact match character calculation unit 620 and the character count of the half-match characters notified by the half-match character calculation unit 630. In addition, the similarity calculation unit 640 notifies the modification unit 650 of the calculated similarity.

The modification unit 650 downwardly modifies the similarity notified by the similarity calculation unit 640, based on the character count of the corrected text data (search target data) and notifies the sorting unit 670 of the downwardly modified similarity.

The sorting unit 670 sorts the product code data based on the downwardly modified similarity notified by the modification unit 650.

Among sorted pieces of the product code data, the output unit 680 transmits N pieces of the product code data (N is any integer. For example, the number of pieces of the product code data whose downwardly modified similarity is equal to or higher than a predetermined threshold value) to the terminal 113 as a result of the voice recognition.

(4) Specific Example of Processing of Text Search Unit

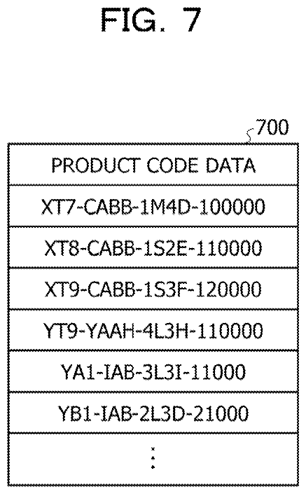

Next, a specific example of processing of the text search unit 350 will be described with reference to FIGS. 7 to 12.

(4-1) Specific Example of Product Code Data

FIG. 7 is a diagram illustrating a specific example of the product code data. As described above, product code data 700 is read from the product code data storage unit 370 by the search target data acquisition unit 610. The product code data 700 read by the search target data acquisition unit 610 includes the product code (in the example in FIG. 7, a character string made up of uppercase alphabetical characters, numbers, or hyphens) of each product handled in the response services.

(4-2) Specific Example of Processing of Exact Match Character Calculation Unit

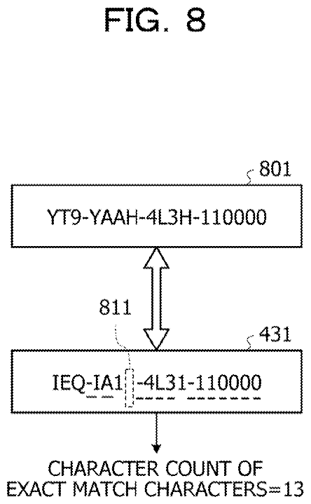

FIG. 8 is a diagram illustrating a specific example of processing of the exact match character calculation unit. For example, the example in FIG. 8 indicates a state in which

the exact match character calculation unit 620 compares
the corrected text data (reference sign 431) notified by the search target data acquisition unit 610, and
the product code data (reference sign 801) described in the fourth line of the product code data 700 notified by the search target data acquisition unit 610.

As illustrated in FIG. 8, in the corrected text data (reference sign 431), the number of characters that exactly match the product code data (reference sign 801) is 13 characters (refer to the underlines). Accordingly, the exact match character calculation unit 620 notifies the similarity calculation unit 640 of 13 characters as the character count of the exact match characters.

Note that, between the corrected text data (reference sign 431) and the product code data (reference sign 801),

the exact match character calculation unit 620 counts the character count of the exact match characters by
comparing the characters at the corresponding positions while moving by one character at a time in a direction from the leftmost character toward the rightmost character, and
comparing the characters contained in a range of a predetermined number of characters before and after the corresponding positions.

For example, in the case of FIG. 8, for the characters arranged after the dotted line rectangle 811, the exact match character calculation unit 620 determines that the characters indicated by the underlines (11 characters in the example in FIG. 8) exactly match by shifting by one character behind. For example, when comparing at least the characters arranged after the dotted line rectangle 811 with the product code data (reference sign 801), the exact match character calculation unit 620 makes a comparison with not only the character of the product code data (reference sign 801) at the corresponding position but also the character located one character behind.

Note that the example in FIG. 8 indicates an example in which the exact match character calculation unit 620 includes the character located one character behind into the comparison target range. However, the characters included in the comparison target range are not limited to the character located one character behind and may be a character located a plurality of characters behind or a character located a plurality of characters ahead. Alternatively, the comparison may be made based on the appearance pattern of the characters, and the exact match characters may be counted.

(4-3) Specific Example of Similar Pronunciation Word Dictionary Data

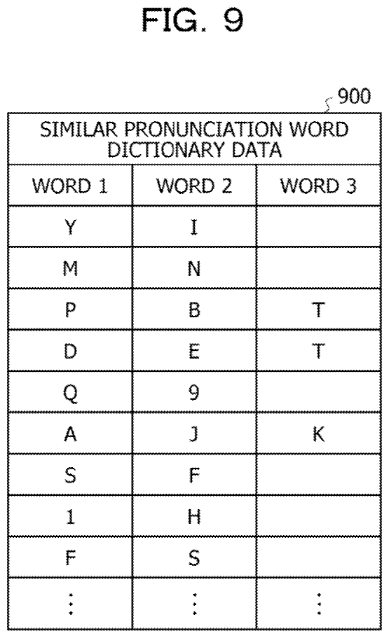

FIG. 9 is a diagram illustrating a specific example of the similar pronunciation word dictionary data. As illustrated in FIG. 9, similar pronunciation word dictionary data 900 includes “word 1”, “word 2”, and “word 3” as information items.

In the “word 1”, a character associated with another word having a similar voice at the time of utterance is stored. In the “word 2”, a first character whose voice at the time of utterance is similar to the character stored in the “word 1” is stored. In the “word 3”, a second character whose voice at the time of utterance is similar to the character stored in the “word 1” is stored.

The example of the similar pronunciation word dictionary data 900 in FIG. 9 indicates that the voice when “Y” is uttered and the voice when “I” is uttered are similar. In addition, the example of the similar pronunciation word dictionary data 900 in FIG. 9 indicates that the voice when “P” is uttered, the voice when “B” is uttered, and the voice when “T” is uttered are similar.

(4-4) Specific Example of Processing of Half-Match Character Calculation Unit

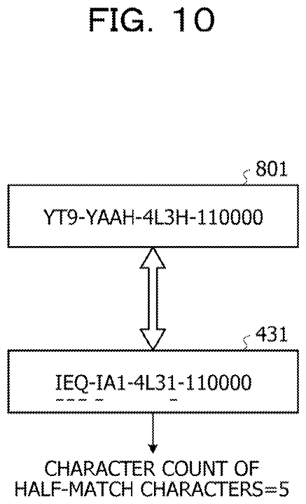

FIG. 10 is a diagram illustrating a specific example of processing of the half-match character calculation unit. For example, a state is indicated in which

the half-match character calculation unit 630 compares
the corrected text data (reference sign 431) notified by the search target data acquisition unit 610, and
the product code data (reference sign 801) described in the fourth line of the product code data 700 notified by the search target data acquisition unit 610.

In the case of FIG. 10, the character count of characters having the relationship indicated by the similar pronunciation word dictionary data 900 (which is the character count of the half-match characters) between the corrected text data (reference sign 431) and the product code data (reference sign 801) is five characters (refer to the underlines). Accordingly, the half-match character calculation unit 630 notifies the similarity calculation unit 640 of five characters as the character count of the half-match characters.

(4-5) Specific Example of Processing of Similarity Calculation Unit

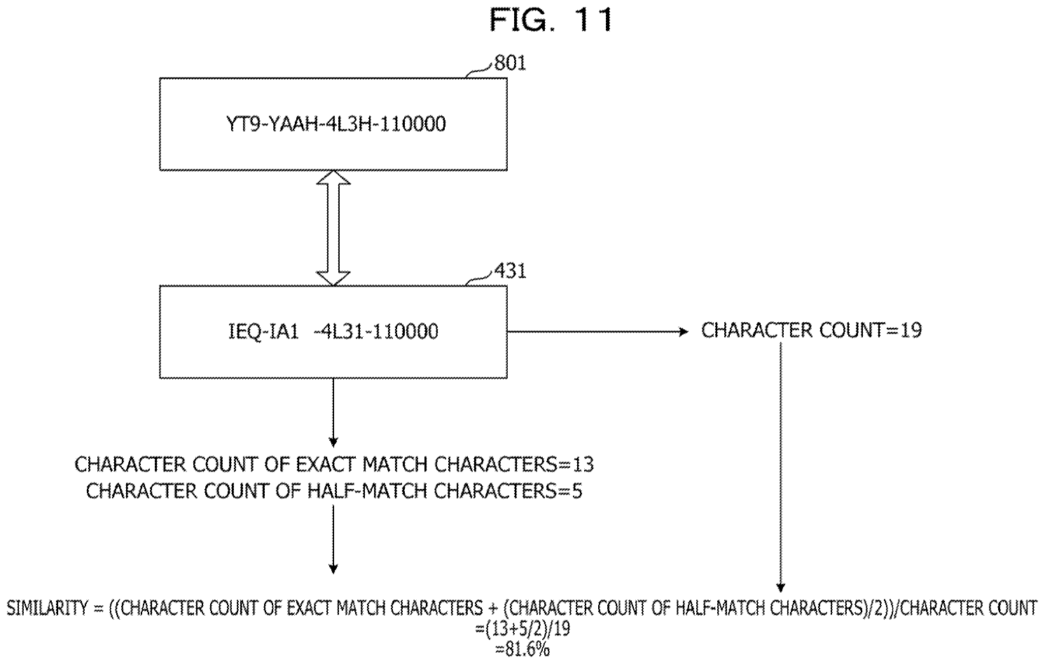

FIG. 11 is a diagram illustrating a specific example of processing of the similarity calculation unit. For example, a state is indicated in which the similarity calculation unit 640 acquires 13 characters from the exact match character calculation unit 620 as the character count of the exact match characters, and five characters from the half-match character calculation unit 630 as the character count of the half-match characters.

As illustrated in FIG. 11, the similarity calculation unit 640 calculates the similarity based on the following equation (Equation 1), using the acquired character count of the exact match characters and the acquired character count of the half-match characters.

Similarity=((Character Count of Exact Match Characters+(Character Count of Half-Match Characters)/2))/Character Count (Equation 1)

Note that, in (Equation 1), the character count of the corrected text data (reference sign 431) (which is the character count of the search target data) is input to the “character count” (19 in the example in FIG. 11).

As illustrated in FIG. 11, in the case of the corrected text data (reference sign 431), the character count of the exact match characters is 13 characters, the character count of the half-match characters is five characters, and the character count of the corrected text data (search target data) is 19 characters. Accordingly, the similarity is calculated to be 81.6%.

(4-6) Specific Example of Processing of Modification Unit

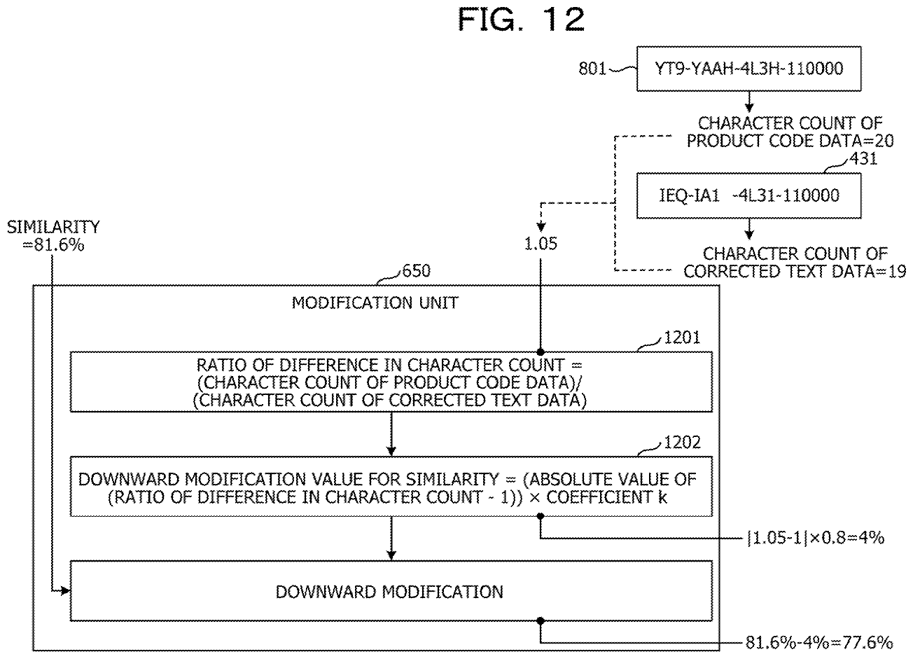

FIG. 12 is a diagram illustrating a specific example of processing of the modification unit. As illustrated in FIG. 12, the modification unit 650 first calculates the ratio of the difference in character count, based on the following equation (Equation 2).

Ratio of Difference in Character Count=(Character Count of Product Code Data)/(Character Count of Corrected Text Data) (Equation 2)

Here, as illustrated in FIG. 12, the character count of the product code data (reference sign 801) is 20 characters, and the character count of the corrected text data (search target data) is 19 characters. Accordingly, the modification unit 650 calculates the ratio of the difference in character count to be 1.05%.

Subsequently, the modification unit 650 calculates a downward modification value for the similarity, based on the following equation (Equation 3).

Downward Modification Value for Similarity=(Absolute Value of (Ratio of Difference in Character Count−1))×Coefficient k (Equation 3)

Here, as illustrated in FIG. 12, the ratio of the difference in character count is 1.05% as described above. In addition, the coefficient k is regarded as “0.8” here. Accordingly, the modification unit 650 calculates the downward modification value for the similarity to be 4%.

Subsequently, the modification unit 650 downwardly modifies the similarity calculated by the similarity calculation unit 640, using the downward modification value for the similarity. In the example in FIG. 12, the similarity calculated by the similarity calculation unit 640 is 81.6%, and the downward modification value for the similarity is 4%. Therefore, the modification unit 650 calculates the downwardly modified similarity to be 77.6%.

<Flow of Search Process>

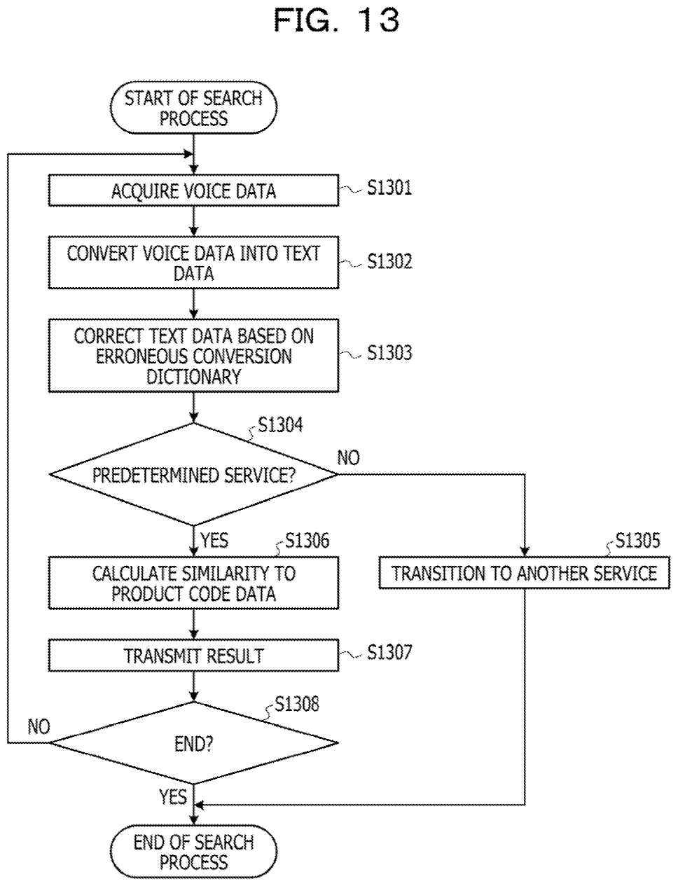

Next, a flow of a search process by the search unit 130 will be described. FIG. 13 is an example of a flowchart illustrating a flow of the search process.

In step S1301, the voice input unit 310 acquires the voice data transmitted from the microphone 112.

In step S1302, the voice recognition unit 320 converts the voice data into text data by performing voice recognition processing on the acquired voice data.

In step S1303, the erroneous conversion correction unit 330 corrects the text data, based on the erroneous conversion dictionary data stored in the erroneous conversion dictionary storage unit 360.

In step S1304, the determination unit 340 determines whether or not a text search is to be performed, by determining whether or not the current service is the “service involving performing voice recognition of the product code with high accuracy”, based on the corrected text data (before deletion). For example, the determination unit 340 determines whether or not a text search is to be performed by determining whether or not the ratio of the characters (search target data) relating to the product code to the corrected text data (before deletion) satisfies a predetermined condition.

When it is determined in step S1304 that the current service is a “service other than the service involving performing voice recognition of the product code with high accuracy” (in the case of No in step S1304), the process proceeds to step S1305.

In step S1305, the determination unit 340 executes the transition process to transition to a function for assisting another service (for example, the question acceptance function or the complaint acceptance function) and ends the search process.

On the other hand, when it is determined in step S1304 that the current service is the “service involving performing voice recognition of the product code with high accuracy” (in the case of Yes in step S1304), the process proceeds to step S1306.

In step S1306, the text search unit 350 performs a text search by calculating the similarity between the corrected text data (search target data) and the product code data.

In step S1307, the text search unit 350 transmits product code data with the highest calculated similarity (or product code data having a similarity equal to or higher than a predetermined threshold value) to the terminal 113 as a result of the voice recognition.

In step S1308, the voice input unit 310 determines whether or not the search process is to be ended. When it is determined in step S1308 that the search process is to be continued (in the case of No in step S1308), the process returns to step S1301. On the other hand, when it is determined in step S1308 that the search process is to be ended (in the case of Yes in step S1308), the search process ends.

As is clear from the above description, the response service assistance device according to the first embodiment acquires voice data and converts the acquired voice data into text data. In addition, the response service assistance device according to the first embodiment specifies the search target data included in the converted text data and, according to the ratio of the search target data to the text data, designates which of a text search for the search target data or the transition process to dealing with the response service is to be executed.

Consequently, according to the response service assistance device according to the first embodiment, voice recognition of the product code may be performed with high accuracy in the “service involving performing voice recognition of the product code with high accuracy”. As a result, according to the first embodiment, appropriate operator support according to the acquired voice data may be provided in the response service.

In addition, in calculating the ratio of the search target data to the text data, the response service assistance device according to the first embodiment corrects the text data based on the erroneous conversion dictionary data. Furthermore, the response service assistance device according to the first embodiment calculates the similarity between the product code data and the corrected text data (search target data), using the character count of the exact match characters, the character count of the half-match characters, and the total character count. Moreover, the response service assistance device according to the first embodiment downwardly modifies the similarity according to the difference between the character count of the product code data and the character count of the corrected text data (search target data) and outputs the product code data according to the downwardly modified similarity as a result of voice recognition.

As described above, the response service assistance device according to the first embodiment corrects the text data in consideration of the operator's habit and the like and also calculates the similarity by a calculation method suitable for the voice data. Consequently, according to the first embodiment, the precise product code may be output as a result of voice recognition.

### Second Embodiment

In the above first embodiment, the character count of the product code data has been described as being divided by the character count of the corrected text data (search target data) when the ratio of the difference between the character count of the product code data and the character count of the corrected text data (search target data) is calculated. However, the modification unit 650 only has to normalize the ratio of the difference in character count and may, for example, divide the character count of the corrected text data (search target data) by the character count of the product code data.

In addition, in the above first embodiment, the product code data 700 in which uppercase alphabetical characters, hyphens, and numbers are combined has been exemplified as the product code data (refer to FIG. 7). However, the format of the product code data is not limited to this, and other characters and symbols such as lowercase alphabetical characters may be included. Alternatively, the product code data may be in a format to which a branch number is attached.

In addition, in the above first embodiment, the search unit 130 has been described as being implemented in the response service assistance device 120, but the search unit 130 may be implemented in a device separate from the response service assistance device 120 (for example, a second response service assistance device).

Note that the embodiments are not limited to the configurations described here and may include combinations of the configurations or the like described in the above embodiments with other elements, and the like. These points may be changed without departing from the spirit of the embodiments and may be appropriately defined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a response service assistance program for causing a computer to execute a process comprising:
acquiring voice data in a response service;
converting the acquired voice data into text data;
specifying search target data included in the converted text data; and
designating which of a text search for the search target data or a transition process to dealing with the response service is to be executed, according to a ratio of the search target data to the text data.

2. The non-transitory computer-readable recording medium according to claim 1, which causes the computer to execute a process comprising:
correcting the converted text data by referring to erroneous conversion dictionary data; and
specifying the search target data included in the corrected text data.

3. The non-transitory computer-readable recording medium according to claim 2, wherein the search target data is characters that relate to a product code that includes alphabets or numbers.

4. The non-transitory computer-readable recording medium according to claim 3, wherein the search target data is generated by deleting characters other than the characters that relate to the product code from the corrected text data.

5. The non-transitory computer-readable recording medium according to claim 4, wherein each character in the search target data and each character in a predefined product code data are compared, and similarity between the search target data and the product code data is calculated.

6. The non-transitory computer-readable recording medium according to claim 1, wherein the text search is executed when the ratio of the search target data to the text data is equal to or higher than a predetermined value, and the transition process to the dealing designated based on the text data is executed when the ratio of the search target data to the text data is lower than the predetermined value.

7. The non-transitory computer-readable recording medium according to claim 5, wherein the similarity is calculated based on as a number of characters that exactly match respective characters in the product code data, among the respective characters in the search target data, and a number of characters that have a predetermined relationship with corresponding characters in the product code data, among the respective characters in the search target data, and a character count of the search target data.

8. The non-transitory computer-readable recording medium according to claim 7, which causes the computer to execute a process comprising
modifying the similarity by using a modification value calculated based on the ratio between the character count of the search target data and the character count of the product code data.

9. An information processing device comprising:
a memory; and
a processor coupled to the memory and configured to:
acquire voice data in a response service;
convert the acquired voice data into text data;
specify search target data included in the converted text data; and
designate which of a text search for the search target data or a transition process to dealing with the response service is to be executed, according to a ratio of the search target data to the text data.

10. A response service assistance method comprising:
acquiring, by a computer, voice data in a response service;
converting the acquired voice data into text data;
specifying search target data included in the converted text data; and
designating which of a text search for the search target data or a transition process to dealing with the response service is to be executed, according to a ratio of the search target data to the text data.
